(19) United States
(12) Patent Application Publication
(10) Pub. No.: US 2017/0062805 A1
(43) Pub. Date: Mar. 2, 2017

(54) FLUORIDE ION BATTERY

(71) Applicants: TOYOTA JIDOSHA KABUSHIKI KAISHA, Toyota-shi (JP); KYOTO UNIVERSITY, Kyoto-shi (JP)

(72) Inventors: Hirofumi NAKAMOTO, Kyoto-shi (JP); Hidenori MIKI, Hiratsuka-shi (JP); Zempachi OGUMI, Kyoto-shi (JP); Takeshi ABE, Takatsuki-shi (JP)

(73) Assignees: TOYOTA JIDOSHA KABUSHIKI KAISHA, Toyota-shi (JP); KYOTO UNIVERSITY, Kyoto-shi (JP)

(21) Appl. No.: 15/231,491

(22) Filed: Aug. 8, 2016

(30) Foreign Application Priority Data
Aug. 31, 2015 (JP) 2015-171343

(51) Int. Cl. H01M 4/134; H01M 4/62; H01M 4/46; H01M 4/1395; C22C 28/00; H01M 10/0568; H01M 10/0569; C22C 21/00; C22C 11/00; H01M 4/04; H01M 10/0567

(52) U.S. Cl. CPC H01M 4/134; H01M 4/0488; H01M 4/625; H01M 4/623; H01M 4/463; H01M 4/1395; H01M 10/0567; H01M 10/0568; H01M 10/0569; C22C 21/00; C22C 11/00; C22C 28/00; H01M 2220/20; H01M 2300/0028

(57) ABSTRACT

An object of the present invention is to provide a fluoride ion battery in which excess voltage at the time of charging is decreased. The present invention achieves the object by providing a fluoride ion battery comprising a cathode active material layer containing a cathode active material, an anode active material layer containing an anode active material, and an electrolyte layer formed between the cathode active material layer and the anode active material layer; wherein the anode active material is an alloy containing at least a Ce element and a Pb element.

### TECHNICAL FIELD

The present invention relates to a fluoride ion battery in which over voltage at the time of charging is decreased.

### BACKGROUND ART

As high-voltage and high-energy density batteries, for example, Li ion batteries are known. The Li ion battery is a cation-based battery utilizing a reaction between a Li ion and a cathode active material and a reaction between a Li ion and an anode active material. Meanwhile, as anion-based batteries, fluoride ion batteries utilizing a reaction of a fluoride ion are known.

For example, Patent Literature 1 discloses an electrochemical cell (a fluoride ion battery) comprising a cathode, an anode, and an electrolyte capable of conducting an anion charge carrier (F⁻). Also, in Patent Literature 1, CeFx is exemplified as a useful fluoride ion host material for the anode.

Patent Literature 2 discloses a secondary solid state current source consisting of an anode (An⁰) in a form of a metal or an alloy, whose fluorination leads to the formation of a fluoride or fluorides with a high isobar formation potential. Also, in Patent Literature 2, a metal (or its alloy) selected from the group consisting of Li, K, Na, Sr, Ba, Ca, Mg, Al, Ce, and La, or from the alloys of the listed metals with the metals, selected from the group of Pb, Cu, Bi, Cd, Zn, Co, Ni, Cr, Sn, Sb, and Fe, is exemplified as the anode material.

Patent Literature 3 discloses a fluoride ion battery comprising an anode, a cathode, an electrolyte comprising a dissolved fluoride salt at least partially dissolved in a solvent, and an additive comprising a fluoride ion complexing species. Also, in Examples of Patent Literature 3, the results in which Pb, PbF₂, and La are used as the anode material are described.

### CITATION LIST

### Patent Literatures

Patent Literature 1: Japanese Patent Application Laid-Open (JP-A) No. 2013-145758

Patent Literature 2: JP-A No. 2008-537312

Patent Literature 3: JP-A No. 2014-501434

### SUMMARY OF INVENTION

### Technical Problem

There is a problem that the over voltage at the time of charging is large when Ce is used as the anode material (anode active material) for a fluoride ion battery. The over voltage refers to a difference between the theoretical potential of an electrochemical reaction and the potential at which the reaction actually proceeds in the electrochemical reaction. Large over voltage at the time of charging increases electricity loss at the time of charging to deteriorate the energy efficiency.

The present invention has been made in view of the above circumstances, and a main object thereof is to provide a fluoride ion battery in which over voltage at the time of charging is decreased.

### Solution to Problem

In order to achieve the object, the present invention provides a fluoride ion battery comprising a cathode active material layer containing a cathode active material, an anode active material layer containing an anode active material, and an electrolyte layer formed between the cathode active material layer and the anode active material layer; wherein the anode active material is an alloy containing at least a Ce element and a Pb element.

According to the present invention, usage of the alloy, in which a Pb element is added to a Ce element, as the anode active material allows a fluoride ion battery with decreased over voltage at the time of charging.

In the invention, the anode active material may further contain an Al element.

### Advantageous Effects of Invention

A fluoride ion battery of the present invention exhibits an effect that can decrease over voltage at the time of charging.

### BRIEF DESCRIPTION OF DRAWINGS

FIG. 1 is a schematic cross-sectional view illustrating an example of a fluoride ion battery of the present invention.

FIGS. 2A to 2D are the results of CV measurement for the measurement samples in Example 1 and Comparative Examples 1 and 2.

FIGS. 3A to 3D are the results of CV measurement for the measurement samples in Example 1 and Comparative Examples 3 and 4.

FIGS. 4A to 4D are the results of CV measurement for the measurement samples in Examples 1 to 3.

FIGS. 5A to 5C are the results of CV measurement for the measurement samples in Examples 3 and 4.

### DESCRIPTION OF EMBODIMENTS

A fluoride ion battery of the present invention is hereinafter described in detail.

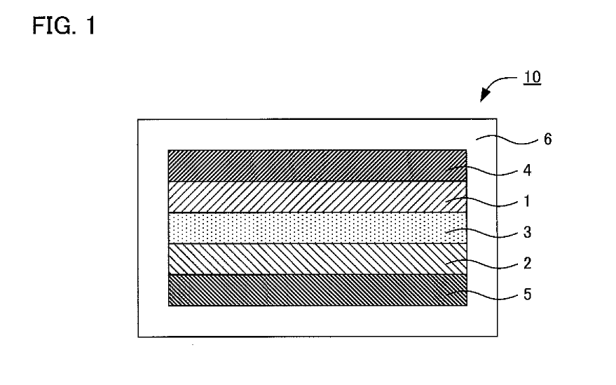

FIG. 1 is a schematic cross-sectional view illustrating an example of a fluoride ion battery of the present invention. The fluoride ion battery 10 shown in FIG. 1 has a cathode active material layer 1 containing a cathode active material, an anode active material layer 2 containing an anode active material, an electrolyte layer 3 formed between the cathode active material layer 1 and the anode active material layer 2, a cathode current collector 4 for collecting currents of the cathode active material layer 1, an anode current collector 5 for collecting currents of the anode active material layer 2, and a battery case 6 for storing these members.

According to the present invention, usage of the alloy, in which a Pb element is added to a Ce element, as the anode active material allows a fluoride ion battery with decreased over voltage at the time of charging. Thus electricity loss at the time of charging is decreased and the improvement of the energy efficiency may be achieved. The reason why the over voltage may be decreased is presumed to be the followings. Namely, it is presumed that the over voltage at the time of charging may be increased for the reason that the side reaction other than the objected reaction (fluoridation and defluorination of Ce) is dominantly proceeded when using a simple substance of Ce. On the contrary, usage of the alloy in which a Pb element is added to a Ce element allows Pb to function as a protective material for Ce, and thus the generation of the side reaction may be restrained to decrease over voltage at the time of charging. The function as the protective material is presumed to be a function of restraining formation of a film with low reaction activity by having an appropriate connectivity with F and by restraining oxidization of Ce by Pb which is chemically more stable than Ce, in specific. Further, the anode active material in the present invention has significantly higher activity of fluoridation and defluorination of Ce compared with that of the conventionally used simple substance of Ce, thereby allows a battery with high capacity.

Incidentally, as described above, Patent Literature 2 exemplifies a metal (or its alloy) selected from the group consisting of Li, K, Na, Sr, Ba, Ca, Mg, Al, Ce, and La, or from the alloys of the listed metals with the metals, selected from the group of Pb, Cu, Bi, Cd, Zn, Co, Ni, Cr, Sn, Sb, and Fe, as the anode material. However, the exemplified combinations are at least 110 kinds (10×11) or more, and the alloy containing a Ce element and a Pb element is not specifically disclosed in Patent Literature 2. Also, as described in later described Examples, selecting the combination of a Ce element and a Pb element allows the effect which can decrease the over voltage at the time of charging to be obtained. This effect is a different effect not disclosed in Patent Literatures 1 to 3.

The fluoride ion battery of the present invention is hereinafter described in each constitution.

### 1. Anode Active Material Layer

An anode active material layer in the present invention is a layer containing at least an anode active material. Also, the anode active material layer may further contain at least one of a conductive material and a binder other than the anode active material.

The anode active material in the present invention is usually an active material that is fluorinated at the time of discharging. Also, the anode active material is usually the alloy containing at least a Ce element and a Pb element. The proportion of the Ce element and the Pb element in the anode active material is not particularly limited. The weight proportion of the Pb element to the Ce element (Pb/Ce) is 0.25 or more for example, may be 0.5 or more, and may be 1 or more. If the proportion of the Pb element is too small, there is a possibility that the side reaction of Ce is not sufficiently restrained. Meanwhile, Pb/Ce is 10 or less for example, may be 6 or less, and may be 2.5 or less. If the proportion of Pb element is too large, there is a possibility that the reaction between Ce and fluoride ion is interfered.

The anode active material in the present invention may be an alloy constituted with just a Ce element and a Pb element, and may be an alloy further containing one kind or two kinds or more of other elements. The other elements are usually the elements that can maintain the function of Pb protecting Ce, and the examples thereof may include an Al element.

The total proportion of the Ce element and the Pb element in the whole anode active material (whole alloy) is 1% by weight or more for example, may be 3% by weight or more, may be 5% by weight or more, and may be 8% by weight or more. On the other hand, the total proportion of the Ce element and the Pb element in the whole anode active material (whole alloy) is 100% by weight at the maximum. Also, the anode active material in the present invention may contain the Ce element and the Pb element as the main components. In this case, the total proportion of the Ce element and the Pb element in the whole alloy is 50% by weight or more for example, may be 70% by weight or more, and may be 90% by weight or more. Meanwhile, the anode active material in the present invention may contain other elements than the Ce element and the Pb element as the main components. In this case, the (total) proportion of the other elements in the whole alloy is 50% by weight or more for example, may be 70% by weight or more, and may be 90% by weight or more.

The shape of the anode active material is not particularly limited, but examples thereof may include a granular shape and a thin film shape. The average particle diameter (D₅₀) of the anode active material is not particularly limited. Also, the producing method for the anode active material is not particularly limited if the method allows the above described alloy to be obtained, but examples thereof may include a melt and quenching method. Specific examples of the melt and quenching method may include the method in which raw materials (such as a simple substance of Ce and a simple substance of Pb) are heated to produce a molten material, and the molten material is contacted with a cooling roll to be quenched.

The conductive material is not particularly limited if the material has the desired electron conductivity, but examples thereof may include a carbon material. Examples of the carbon material may include carbon blacks such as acetylene black, Ketjen black, a furnace black, a thermal black, and graphene, fullerene, and carbon nanotube. On the other hand, the binder is not particularly limited if it is chemically and electronically stable, but examples thereof may include fluorine-based binders such as polyvinylidene fluoride (PVDF) and polytetrafluoroethylene (PTFE).

Also, the content of the anode active material in the anode active material layer is preferably larger in the view point of the capacity, and is 30% by weight for example, preferably 50% by weight or more, and more preferably 70% by weight or more. Also, the thickness of the anode active material layer varies greatly in accordance with the constitutions of the battery, and is not particularly limited.

### 2. Cathode Active Material Layer

The cathode active material layer in the present invention is a layer containing at least a cathode active material. Also, the cathode active material layer may further contain at least one of the conductive material and the binder other than the cathode active material.

The cathode active material in the present invention is usually an active material which is defluorinated at the time of discharging. Also, for the cathode active material, an arbitrary active material having higher potential than that of the anode active material may be selected. Examples of the cathode active material may include a simple substance of metal, an alloy, a metal oxide, and fluorides of these. Examples of the metal element contained in the cathode active material may include Cu, Ag, Ni, Co, Pb, Ce, Mn, Au, Pt, Rh, V, Os, Ru, Fe, Cr, Bi, Nb, Sb, Ti, Sn, and Zn. Above all, the cathode active material is preferably Cu, CuFx, Pb, PbFx, Bi, BiFx, Ag, and AgFx. Incidentally, above described “x” is a real number larger than 0. Also, other examples of the cathode active material may include a carbon material and the fluoride thereof. Examples of the carbon material may include graphite, coke, and carbon nanotube. Also, further other examples of the cathode active material may include a polymer material. Examples of the polymer material may include polyaniline, polypyrrole, polyacetylene, and polythiophene.

In terms of the conductive material and the binder, the same materials as described in “1. Anode active material layer” above may be used. Also, the content of the cathode active material in the cathode active material layer is preferably larger in the view point of the capacity, and is 30% by weight or more for example, preferably 50% by weight or more, and more preferably 70% by weight or more. Also, the thickness of the cathode active material varies greatly in accordance with the constitutions of the battery, and is not particularly limited.

### 3. Electrolyte Layer

The electrolyte layer in the present invention is a layer formed between the cathode active material layer and the anode active material layer. The electrolyte material constituting the electrolyte layer may be electrolyte solution (liquid electrolyte), and may be a solid electrolyte material.

The liquid electrolyte in the present invention contains a fluoride salt and an organic solvent, for example. The fluoride salt is not particularly limited if it produces fluoride ion that reacts with an active material, and may be an inorganic fluoride salt, and may be an organic fluoride salt. Also, fluoride salt may be liquid ion. Examples of the inorganic fluoride salt may include XF (X represents Li, Na, K, Rb, or Cs).

Examples of the cations of the organic fluoride salt may include alkyl ammonium cation, alkyl phosphonium cation, and alkyl sulfonium cation. Examples of the alkyl ammonium cation may include the cation represented by N⁺(R¹R²R³R⁴).

Incidentally, R¹ to R⁴ are each independently an alkyl group or a fluoro-alkyl group. The carbon number of R¹ to R⁴ is usually 10 or less. Typical examples of the alkyl ammonium cation may include tetramethyl ammonium cation.

The concentration of the fluoride salt in the liquid electrolyte is within a range of 0.1 mol % to 40 mol % for example, and preferably within a range of 1 mol % to 10 mol %.

The organic solvent of the liquid electrolyte is usually a solvent that dissolves the fluoride salt. Examples of the organic solvent may include a glyme represented by a general formula R¹—O(CH₂CH₂O)ₙ—R² (R¹ and R² are each independently an alkyl group with the carbon number 4 or less, or a fluoro alkyl group with the carbon number 4 or less, and “n” is within a range of 2 to 10).

Specific examples of the glyme may include diethylene glycol diethyl ether (G2), tri-ethylene glycol dimethyl ether (G3), tetra-ethylene glycol dimethyl ether (G4), diethylene glycol dibutyl ether, diethylene glycol methyl ethyl ether, tri-ethylene glycol methyl ethyl ether, and tri-ethylene glycol butyl methyl ether.

Other examples of the organic solvent may include nonaqueous solvent. Examples of the nonaqueous solvent may include cyclic carbonates such as ethylene carbonate (EC), fluoro ethylene carbonate (FEC), di-fluoro ethylene carbonate (DFEC), propylene carbonate (PC), butylene carbonate (BC), and chain carbonates such as dimethyl carbonate (DMC), diethyl carbonate (DEC), and ethyl methyl carbonate (EMC). Also, ionic solution may be used as the organic solvent.

The liquid electrolyte in the present invention may be constituted with just the fluoride salt and the organic solvent, or may further contain other compounds. Examples of the other compound may include a Li amide salt having Li ion and sulfonyl amide anion. Sulfonyl amide anion is the anion in which N (anion centered) in amide anion and S of a sulfonyl group are bonded. Examples of the sulfonyl amide anion may include bisfluoro sulfonyl amide (FSA) anion and bistrifuloro methane sulfonyl amide (TFSA) anion. Incidentally, the liquid electrolyte in the present invention preferably contains an inorganic fluoride salt, a Li amide salt, and glyme as described in later described Examples.

On the other hand, examples of the solid electrolyte material may include fluorides of lanthanoid elements such as La and Ce, fluorides of alkali elements such as L , Na, K, Rb, and Cs, and fluorides of alkaline-earth elements such as Ca, Sr, and Ba.

Also, the thickness of the electrolyte layer in the present invention greatly varies in accordance with the constitutions of the battery and not particularly limited.

### 4. Other Constitutions

The fluoride ion battery of the present invention comprises at least the above described anode active material layer, cathode active material layer and electrolyte layer. Further, the battery usually has the cathode current collector for collecting currents of the cathode active material layer and the anode current collector for collecting currents of the anode active material layer. Examples of the shape of the current collectors may include a foil shape, a mesh shape and a porous shape. Also, the fluoride ion battery of the present invention may have a separator between the cathode active material layer and the anode active material layer. The reason therefore is to obtain a battery with higher safety.

### 5. Fluoride Ion Battery

The fluoride ion battery of the present invention may be a primary battery or a secondary battery, but preferably a secondary battery among them. The reason therefore is to be repeatedly charged and discharged and be useful as a car-mounted battery, for example. Incidentally, the primary battery includes the usage of a secondary battery as a primary battery (the usage for the purpose only to one time discharge after being charged). Also, examples of the shape of the fluoride ion battery of the present invention may include a coin shape, a laminate shape, a cylindrical shape and a rectangular shape.

Incidentally, the present invention is not limited to the above embodiments. The embodiments are exemplification, and any is included in the technical scope of the present invention if it has substantially the same constitution as the technical idea described in the claim of the present invention and offers similar operation and effect thereto.

### EXAMPLES

The present invention is described more specifically with reference to examples hereinafter. Incidentally, all measurement samples were produced in a glove box under Ar atmosphere.

### Example 1

A CePb alloy ribbon (weight ratio of Ce:Pb=1:1, manufactured by JAPAN PURE CHEMICAL CO., LTD.) produced by the melt and quenching method was used as the measurement sample. Meanwhile, the liquid electrolyte was obtained by mixing tetra-glyme (G4, manufactured by Kishida Chemical Co., Ltd.) with lithium bisfluoro sulfonyl amide (Li-FSA, manufactured by Kishida Chemical Co., Ltd.) and cesium fluoride (CsF, manufactured by KANTO CHEMICAL CO., INC.) so as to be 4.5 M and 0.45 M respectively, and then stirring the mixture in a sealed vessel made of fluoride resin under the condition of 30° C. In this manner, a measurement sample and a liquid electrolyte were prepared.

### Example 2

A measurement sample and a liquid electrolyte were prepared in the same manner as in Example 1 except that an AlCePb alloy ribbon (weight ratio of Al:Ce:Pb=96:4:5) produced by the melt and quenching method was used as the measurement sample.

### Example 3

A measurement sample and a liquid electrolyte were prepared in the same manner as in Example 1 except that an AlCePb alloy ribbon (weight ratio of Al:Ce:Pb=96:4:10) produced by the melt and quenching method was used as the measurement sample.

### Example 4

A liquid electrolyte was obtained by mixing tri-glyme (G3, manufactured by KANTO CHEMICAL CO., INC.) with lithium bisfluoro sulfonyl amide (Li-FSA, manufactured by Kishida Chemical Co., Ltd.) and lithium fluoride (LiF, manufactured by JAPAN PURE CHEMICAL CO., LTD.) so as to be 5.5 M and 2.75 M respectively, and then stirring the mixture in a sealed vessel made of fluoride resin under the condition of 30° C. A measurement sample and a liquid electrolyte were prepared in the same manner as in Example 3 except that this liquid electrolyte was used.

### Comparative Example 1

A measurement sample and a liquid electrolyte were prepared in the same manner as in Example 1 except that a Ce foil (99.9% purity, manufactured by Rheometric Scientific Inc.) was used as the measurement sample.

### Comparative Example 2

A measurement sample and a liquid electrolyte were prepared in the same manner as in Example 1 except that an AlCe alloy ribbon (weight ratio of Al:Ce=96:4) produced by the melt and quenching method was used as the measurement sample.

### Comparative Example

A measurement sample and a liquid electrolyte were prepared in the same manner as in Example 1 except that a Pb plate (99.9% purity, manufactured by The Nilaco Corporation) was used as the measurement sample.

### Comparative Example 4

A measurement sample and a liquid electrolyte were prepared in the same manner as in Example 1 except that a PbAl alloy ribbon (weight ratio of Pb:Al=7:3) produced by the melt and quenching method was used as the measurement sample.

### Evaluation

### (Cyclic Voltammetry Measurement)

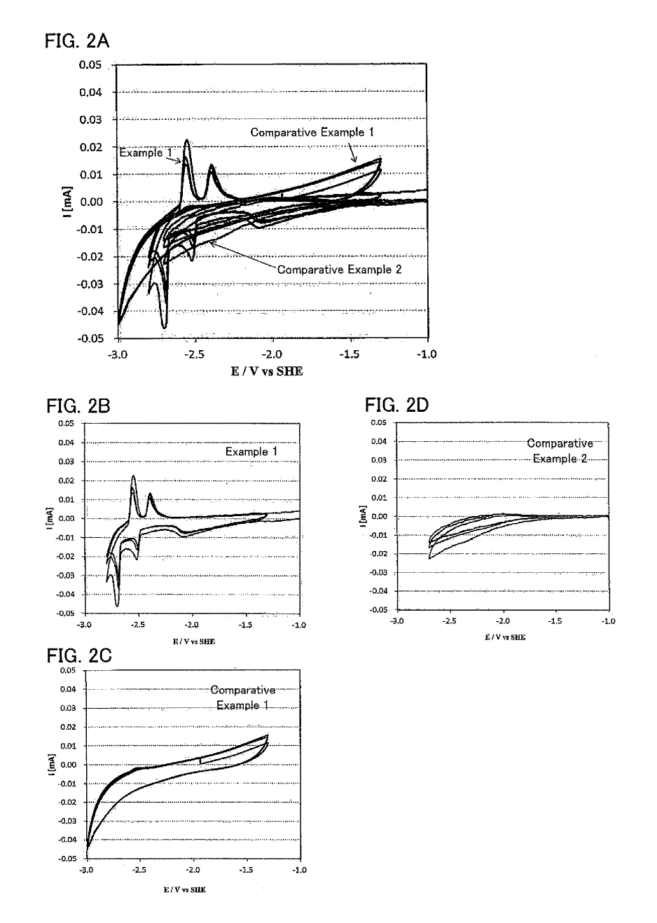

CV measurement was conducted for the measurement samples of Examples 1 to 4 and Comparative Examples 1 to 4 in each liquid electrolyte. Specifically, the measurement samples were evaluated by using a dip-style three electrodes cell in a glove box under Ar atmosphere. The measurement sample was used for the acting electrode and the mixture electrode of PTFE, acetylene black (AB), and carbon fluoride was used for the counter electrode. Incidentally, the mixture electrode is the electrode containing the mixture at the weight ratio of PTFE:AB:carbon fluoride=1:2:7. Also, the reference electrode was isolated from the liquid electrolyte by using Vycor™ glass. Incidentally, used reference electrode was such that an Ag line was soaked in acetonitrile solution, in which silver nitrate and tetrabutyl ammonium perchlorate were dissolved at 0.1 M respectively. Also, the measurement was conducted under the condition of room temperature and 1 mV/s sweep rate. The results are shown in FIGS. 2A to 5C. Incidentally, the potential of the horizontal axis is the potential based on standard hydrogen electrode (SHE).

First, FIG. 2A is the result of CV measurement for the measurement samples in Example 1 and Comparative Examples 1 and 2, and FIGS. 2B to 2D are the each result shown separately. As shown in FIGS. 2A to 2D, in Example 1 (CePb), reduction current peaks were observed in the vicinity of −2.5 V and in the vicinity of −2.7 V. These peaks were not observed in Comparative Example 1 (Ce) and Comparative Example 2 (CeAl). It is presumed that the reduction current peak in the vicinity of −2.7 V is the peak showing defluorination of CeF₃ since the theoretical potential of fluoridation and defluorination of Ce is −2.6 V. Also, it is presumed that the reduction current peak in the vicinity of −2.5 V is the peak showing Li-alloying of Pb (alloying of Pb and Li of lithium salt contained in the liquid electrolyte).

On the other hand, in Example 1 (CePb), oxidation current peaks were observed in the vicinity of −2.55 V and the vicinity of −2.4 V. It is presumed that the oxidation current peak in the vicinity of −2.55 V is the peak showing fluoridation of Ce since a little increase in the oxidation current is observed in the vicinity of −2.55 V in Comparative Example 1 (Ce) as well. Also, it is presumed that the oxidation current peak in the vicinity of −2.4 V is the peak showing de-Li reaction of Li-alloyed Pb.

From the above, in comparison of Example 1 with Comparative Examples 1 and 2, it was confirmed that the activity of fluoridation and defluorination of Ce was significantly improved when a CePb alloy was used. Also, in Comparative Example 1 (Ce), the peak which shows defluorination of CeF₃ was slightly observed in the vicinity of −2.95 V. It was suggested that large over voltage was necessary for causing the main reaction (defluorination of CeF₃) since the side reaction is easily caused when using a simple substance of Ce considering that the theoretical potential of fluoridation and defluorination of Ce is −2.6 V. On the contrary, in Example 1 (CePb), it was confirmed that the over voltage at the time of charging was decreased since the reaction was caused at almost theoretical potential.

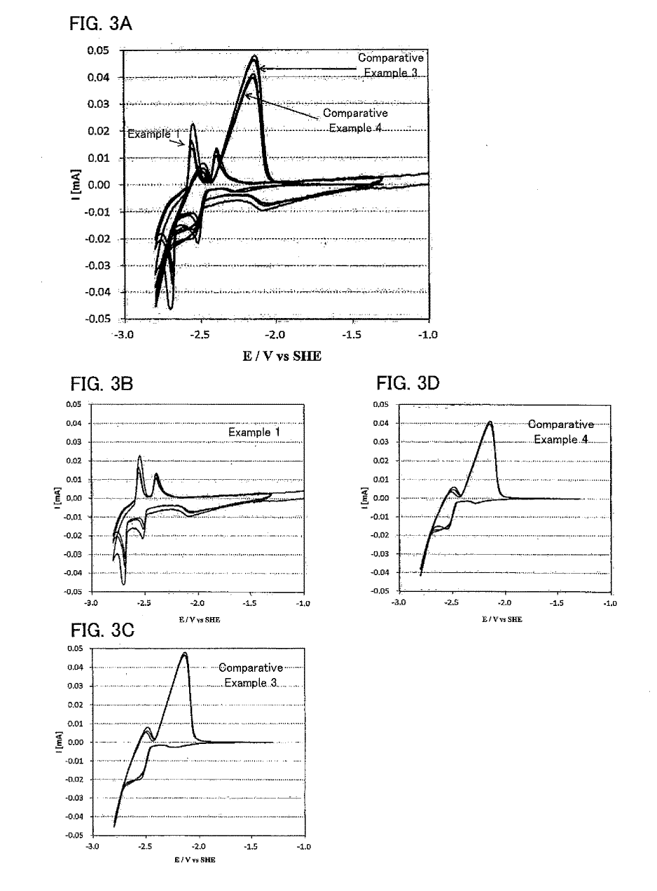

Next, FIG. 3A is the result of CV measurement for the measurement samples in Example 1 and Comparative Examples 3 and 4, and FIGS. 3B to 3D are the each result shown separately. From the results of FIGS. 3A to 3D also, it was suggested that the above presumption was appropriate. Specifically, as shown in FIGS. 3A to 3D, in each of Example 1 (CePb), Comparative Example 3 (Pb) and Comparative Example 4 (PbAl), the reduction current peak was observed in the vicinity of −2.5 V. Accordingly, it was suggested that the peak in the vicinity of −2.5 V was the peak showing Li-alloying of Pb. Also, in Example 1 (CePb), the reduction current peak was observed in the vicinity of −2.7 V. This peak was not observed in Comparative Example 3 (Pb) and Comparative Example 4 (PbAl). Accordingly, it was suggested that the reduction current peak in the vicinity of −2.7 V was the peak showing defluorination of CeF₃.

On the other hand, in Comparative Example 3 (Pb) and Comparative Example 4 (PbAl), the oxidation current peak in the vicinity of −2.55 V and the oxidation current peak rising from the vicinity of −2.5 V were observed similarly to Example 1 (CePb). However, in terms of the oxidation current peak in the vicinity of −2.55 V, the movement in Example 1 (CePb) containing Ce largely differed from the movement in Comparative Example 3 (Pb) and Comparative Example 4 (PbAl) not containing Ce. Specifically, in Example 1 (CePb) that contains Ce, the oxidation current peak in the vicinity of −2.55 V is larger than the oxidation current peak rising from the vicinity of −2.5 V. On the contrary, in Comparative Example 3 (Pb) and Comparative Example 4 (PbAl) that do not contain Ce, the large/small relation of the peak is vice versa. This result suggests that the oxidation current peaks in the vicinity of −2.55 V are each different reaction peak in Example 1 (CePb) containing Ce, and Comparative Example 3 (Pb) and Comparative Example 4 (PbAl) not containing Ce. Further, it was suggested that the oxidation current peak in the vicinity of −2.55 V was the peak showing fluoridation of Ce considering that the theoretical potential of fluoridation and defluorination of Ce is −2.6 V.

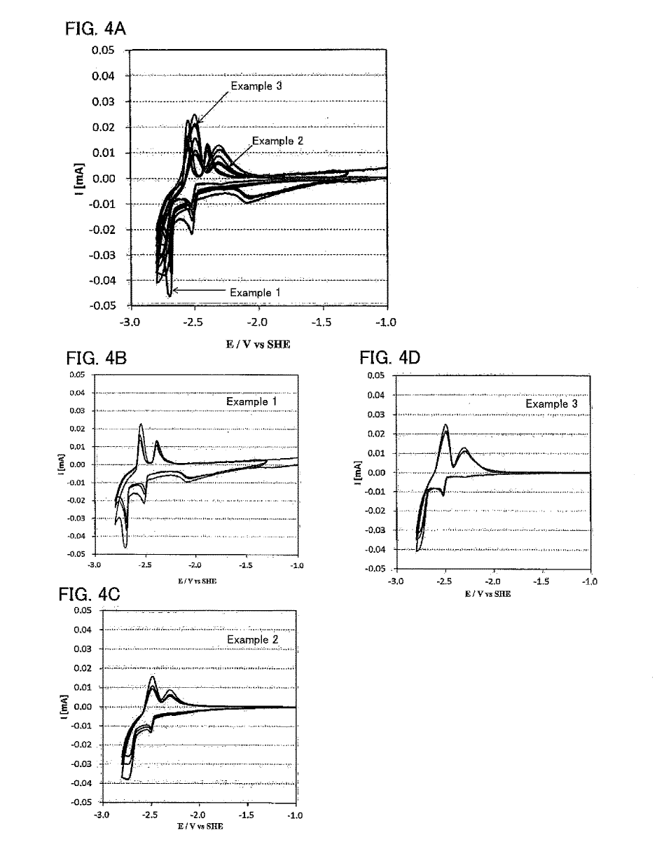

Next, FIG. 4A is the result of CV measurement for the measurement samples in Examples 1 to 3, and FIGS. 4B to 4D are the each result shown separately. As shown in FIGS. 4A to 4D, in each of Example 1 (CePb), Examples 2 and 3 (AlCePb), the reduction current peak was observed in the vicinity of −2.7 V (peak of defluorination of CeF₃), and the oxidation current peak was observed in the vicinity of −2.5 V (peak of fluorination of Ce). Accordingly, it was confirmed that the activity of fluoridation and defluorination of Ce was improved also in the anode active material containing a third component (an Al element here) in addition to a Ce element and a Pb element, compared to the activity in a simple substance of Ce. Also, when comparing Example 2 with Example 3, the similar reduction current peaks and oxidation current peaks were observed even though the proportion of the Pb element was different, and occurrence of fluoridation and defluorination reaction of Ce was confirmed.

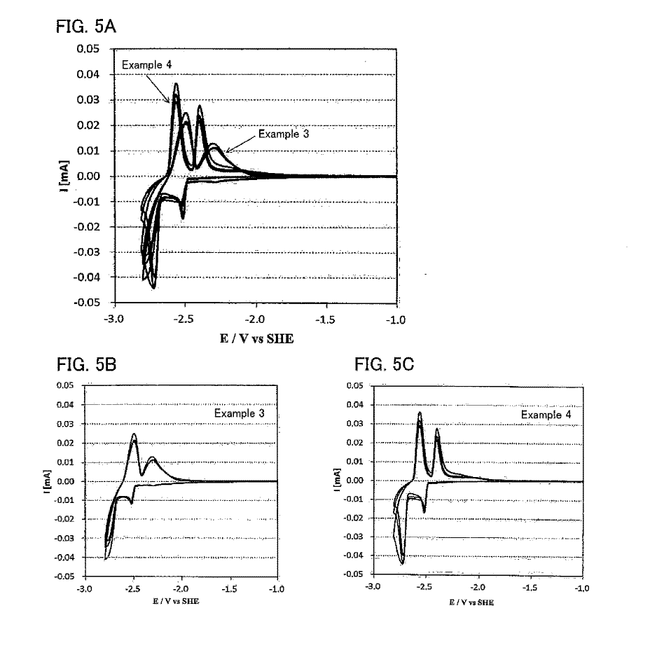

Next, FIG. 5A is the result of CV measurement for the measurement samples in Examples 3 and 4, and FIGS. 5B and 5C are the each result shown separately. As shown in FIGS. 5A to 5C, in each of Examples 3 and 4 (AlCePb), the reduction current peak was observed in the vicinity of −2.7 V even though the kind of the liquid electrolyte was different, and the oxidation current peak was observed in the vicinity of −2.5 V. Accordingly, occurrence of fluorination and defluorination reaction of Ce was confirmed since the similar reduction current peaks and oxidation current peaks were observed even though the kinds of the liquid electrolyte are different.

### REFERENCE SIGNS LIST

1 cathode active material layer
2 anode active material layer
3 electrolyte layer
4 cathode current collector
5 anode current collector
6 battery case
10 fluoride ion battery

What is claimed is:

1. A fluoride ion battery, comprising:
a cathode active material layer containing a cathode active material, an anode active material layer containing an anode active material, and an electrolyte layer formed between the cathode active material layer and the anode active material layer;
wherein the anode active material is an alloy containing at least a Ce element and a Pb element.

2. The fluoride ion battery according to claim 1, wherein the anode active material further contains an Al element.
